(19) United States
(12) Patent Application Publication
(10) Pub. No.: US 2017/0001406 A1
(43) Pub. Date: Jan. 5, 2017

(54) BIODEGRADABLE MULTI-LAYER PASSIVE THERMAL INSULATOR MATERIAL

(71) Applicants: Edwin X. GRAF, Washington Island, WI (US); Robert T. KERY, Castle Cove (AU); Catherine J. HEIMBACH, Neenah, WI (US)

(72) Inventors: Edwin X. GRAF, Washington Island, WI (US); Robert T. KERY, Castle Cove (AU); Catherine J. HEIMBACH, Neenah, WI (US)

(21) Appl. No.: 15/113,651

(22) PCT Filed: Jan. 20, 2015
(86) PCT No.: PCT/US15/12091

§ 371 Date: Jul. 22, 2016

(30) Foreign Application Priority Data
Jan. 24, 2014 (AU) 2014900207

(51) Int. Cl. B32B 3/10; B32B 9/02; B32B 9/04; B32B 5/02

(52) U.S. Cl. CPC B32B 3/10; B32B 5/022; B32B 5/024; B32B 9/02; B32B 9/047; B32B 2307/304; B32B 2307/7163; B32B 2307/7265; B32B 2439/00

(57) ABSTRACT

Disclosed herein is a general purpose, low-cost, highly efficient, biodegradable multi-layer, passive thermal insulator material that can be used for packaging in any application where tight temperature tolerance is required for extended periods. The material comprises inner layers between two outer layers. The outer layers can be themselves multiple layers that may provide strength and moisture protection to the structure. The inner layers can comprise a series of alternating courses of continuous material and discontinuous material containing gaps that can form pockets where the continuous layers are arranged to provide a barrier to seal a gas in the pockets in the discontinuous material.

### CROSS-REFERENCE TO RELATED APPLICATIONS

This application claims priority to Australian Provisional Application Number 2014900207, filed Jan. 24, 2014, the entirety of which is incorporated herein by reference.

### INTRODUCTION

Described herein is a general purpose, low-cost, highly efficient, biodegradable multi-layer, passive thermal insulator material that can be used for packaging in any application where tight temperature tolerance is required for extended periods.

The material comprises inner layers positioned between outer layers. The outer layers can be themselves multiple layers and may provide strength and moisture protection to the structure, For example, the outer layers may comprise from 2-30 or more layers. The inner layers may comprise a series of alternating courses of continuous material and discontinuous material containing gaps that can form pockets where the continuous layers are arranged to provide a barrier to seal a gas in the pockets in the discontinuous material. The use of multiple layers exploits the interface effect to enhance the thermal resistivity of the structure.

There are many embodiments of the biodegradable multi-layer, passive thermal insulator material including the use therein of various materials for the outer layers and the inner continuous and discontinuous layers. Moreover, the layers can be integrated with a wide range of static and/or active thermal materials. By using low cost, biodegradable materials and simple manufacturing processes the present products are versatile and cost effective.

### BACKGROUND

Improper temperature management greatly deteriorates the overall quality of food and is a leading cause of food spoilage. Food packaging in all phases of the supply chain is the main element for the proper control of temperature and thereby the preservation of food quality as food packaging provides barrier protection, communicates information about freshness and controls physical integrity of its contents.

Thermostatic food packaging solutions are capable of directly assisting in regulating temperature and thereby improving the condition or extending the life of food products. With a market over $2.5 billion (in 2013), thermostatic packaging is a growing tool to protect and extend the quality of food at consumption.

By way of background, reference can be made to a thermal insulation material made for a seismograph that would operate on the Moon where the day-night cycle undergoes a temperature range >250° C., i.e., from −180° C. to +90° C., conditions not suitable for the operation of the highly sensitive instrument. A thermal insulating blanket was designed using a multi-layer concept similar to the present but of different, much more expensive, and more environmentally resistant materials. While that material was effective and served its purpose in a highly specialized application, the present materials are more economical such that they can be used in everyday application and are biodegradable.

Of the products available in the market today, few can actively adjust the temperature to achieve desired temperatures “on demand” or passively affect the internal temperature based on external temperatures.

While thermostatic packaging solutions can come in many forms, they are often divided into active or passive modes of operation. “Active” modes of packaging can compensate for temperature loss/gain to maintain the ideal temperature range or it can lower/raise temperature in order to reach a desired temperature range, e.g. prior to consumption. “Passive” modes of packaging do not offer or generate temperature changes but offer resistance to changes of temperature through effective insulation.

The ideal thermostatic solution satisfies the fol lowing;
maintain the temperature of the product within a target range for a target period
is economically beneficial, i, e., it is sufficiently low cost to warrant its use based on the improved quality or improved shelf-life of the product it protects
does not interfere with the product in any way
can be used sustainably.
   The biodegradable multi-layer, passive thermal insulator material described herein presents a passive packaging solution that addresses these four conditions.

### SUMMARY

The materials described herein provide for a low-cost, highly efficient, bio-degradable multi-layer, passive thermal insulator material that can be used for packaging in any application where tight temperature tolerance is required for extended periods such as foodstuffs and other temperature sensitive substances. In addition, the biodegradable multi-layer, passive thermal insulator material can be used in place of plastic back sheet covers conventionally used in diapers, incontinence products and feminine care products.

The biodegradable multi-layer, passive thermal insulator material comprises a series of inner layers sandwiched between outer layers. The outer layers themselves may be multiple layers and may provide strength and moisture protection to the overall structure. The inner layers may comprise a series of alternating courses of continuous material and discontinuous material containing gaps that can form pockets. The function of the continuous material is to provide a barrier to seal a gas in the pockets in the discontinuous material to form an effective thermal barrier. The use of multiple layers exploits the interface effect to enhance the thermal resistivity of the structure.

In some embodiments the inner layer comprises continuous layers that comprise newsprint or similar material interleaved with a layer of discontinuous woven or non-woven mesh material such as cheesecloth. Further, to provide structural strength and moisture protection in some embodiments the outer layers comprise a layer of chitosan coated with beeswax or similar biodegradable coating. Depending on the application, the number of total layers in the biodegradable multi-layer, passive thermal insulator material can be small, e.g., 3-5, or large, e.g., 20 or more, allowing the insulating properties to be adjusted to that required in any specific application. It is estimated that a packaging material having 10 discontinuous layers can be created with a thermal resistivity of 27 mK/W or more. This compares favorably with existing synthetic packaging materials.

### BRIEF DESCRIPTION OF THE DRAWINGS

FIG. 1 is a schematic illustrating one embodiment where the multi-layer, passive thermal insulator material comprises one discontinuous layer.

FIG. 2 is a schematic illustrating one embodiment where the multi-layer, passive thermal insulator material comprises three discontinuous layers.

FIG. 3 is a schematic illustrating one embodiment where the multi-layer, passive thermal insulator material comprises five discontinuous layers.

### DETAILED DESCRIPTION

The present biodegradable multi-layer, passive thermal insulator material is formed as a series of layers resulting in a “sandwich” comprising an inner layer that is lined on each side with an outer layer for strength and moisture protection. Each of the inner layer and the outer layer can comprise multilayers.

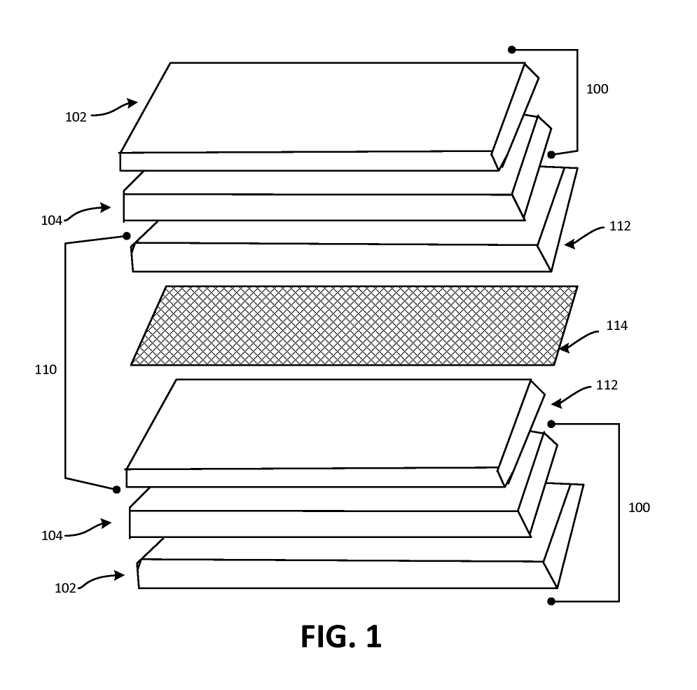

FIG. 1 illustrates an embodiment that comprises inner layer 110 sandwiched between outer layers 100. Each outer layer 100 comprises layers 102 and 104. Inner layer 110 comprises a discontinuous layer 114 sandwiched between continuous layers 112. The assembly of layers is manufactured in a fashion so that the final product contains trapped gas within the discontinuous layer 114. The trapped gas may be air, carbon dioxide, or any other gas of high thermal resistivity.

An exemplary material that can be used for continuous layers 112 is newsprint, a highly available and low cost commodity that has great thermal insulation properties and is biodegradable. To function under more extreme requirements a continuous layer 112 may have a reflective coating applied thereto to provide even greater insulation properties. A metalized, e.g., Al, Ag, Au, continuous membrane will also work and provide very good insulation.

Various woven and nonwoven materials may be used as discontinuous layer 114 as long as the material will trap a gas in the final product. For example, discontinuous layer 114 may comprise a mesh material such as fine cheesecloth. Cheesecloth is a readily available, low cost material with spacing ideally suited for trapping a gas. Cheesecloth made from cotton is also biodegradable. Alternatives include dimple paper which is also low cost, low thermal conductivity and will trap pockets of a gas.

Outer layer 100 in some embodiments can comprise chitosan as layer 104 coated with beeswax as layer 102 for strength and moisture protection. Chitosan is a natural poly-cationic biopolymer derived from the exoskeletons of crustaceans. It is a polyglucosamine with a cellulose backbone, which by dissolving into solution with weak acids, can be manipulated to form materials and fills with a variety of properties. Chitosan is ideally suited as layer 104 as it can provide strength while its non-toxic, non-allergenic properties make it safe for food. In addition it is readily biodegradable and has known antimicrobial properties that can be enhanced by the incorporation of Zn, Cu, Ag, boric acid, borates, antimicrobial weak acids or other antimicrobial substances.

Alternatives to chitosan as layer 104 include but are not limited to a mixture of starch with polyvinyl alcohol or a material called biolatexe, both of which are biodegradable and FDA approved. Other alternatives which are less environmentally benign but may still be used include polyethylene or polypropylene having a UV inhibitor. Alternatives to beeswax as layer 102 include materials that provide moisture protection such as paraffin. Layer 102 may also contain antimicrobial substances.

When used in the inner layer 110, both the newsprint and the cheesecloth are directly biodegradable. Moreover the chitosan layer will decompose once the protective beeswax layer is compromised. This will occur due to gradual water penetration over time.

While it is preferred that biodegradable materials are used in the multi-layer, passive thermal insulator material, non-biodegradable materials may be used as desired. For example, polymeric, ceramic or metallic woven or nonwoven mesh materials may be used as discontinuous layer 114 and non-biodegradable materials such as plastics can be used in the various layers.

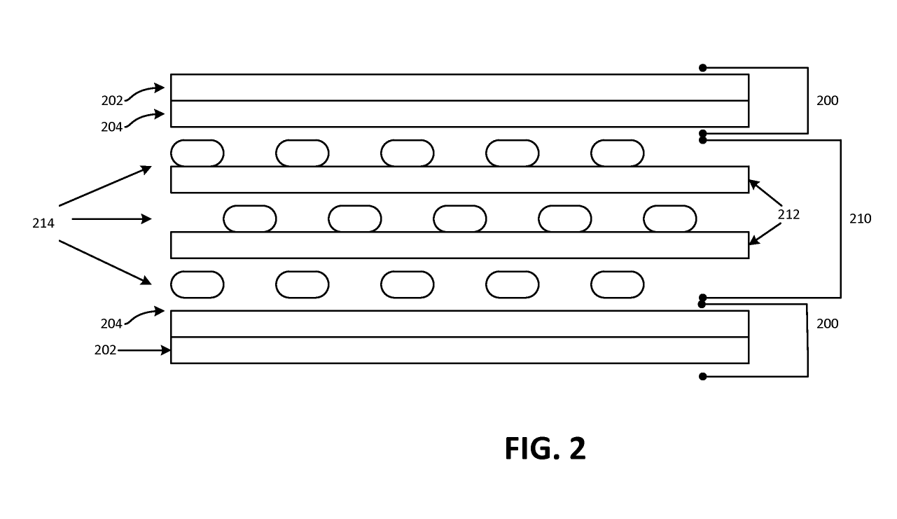

FIG. 2 illustrates an embodiment that comprises inner layer 210 that contains three discontinuous layers sandwiched between outer layers 200. Each outer layer 200 comprises layers 202 and 204. Inner layer 210 comprises discontinuous layers 214 sandwiched between continuous layers 212. The assembly of layers is manufactured in a fashion so that the final product contains trapped gas within the discontinuous layers 214.

The same or similar materials described above in relation to the embodiment illustrated in Fig. I may be used in the various layers of the biodegradable multi-layer, passive thermal insulator material illustrated in FIG. 2.

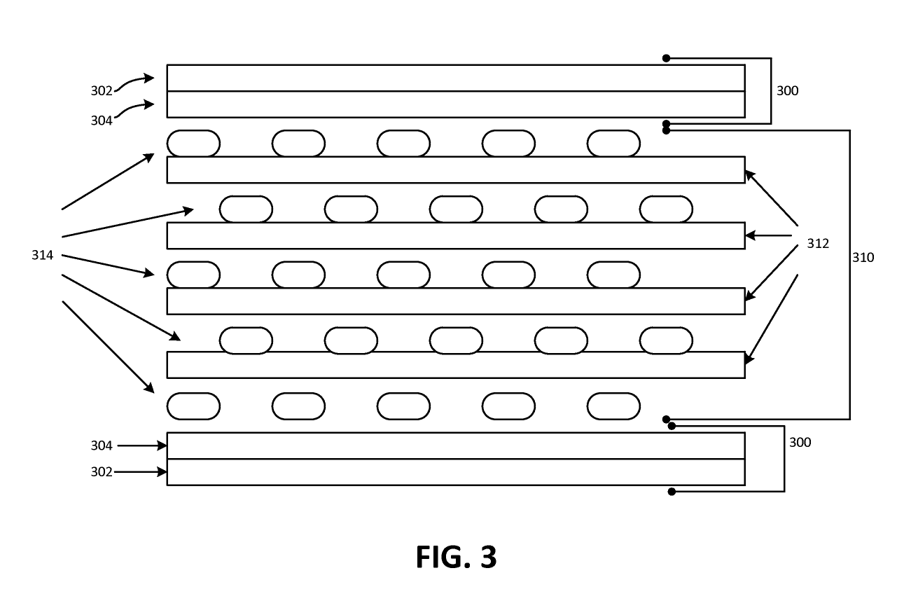

FIG. 3 illustrates an embodiment that comprises inner layer 310 that contains five discontinuous layers sandwiched between outer layers 300. Each outer layer 310 comprises layers 302 and 304. Inner layer 310 comprises discontinuous layers 314 sandwiched between continuous layers 312. The assembly of layers is manufactured in a fashion so that the final product contains trapped gas within the discontinuous layers 314.

The same or similar materials described above in relation to the embodiment illustrated in Fig. I may be used in the various layers of the biodegradable multi-layer, passive thermal insulator material illustrated in FIG. 3.

In joining the various layers to form the biodegradable multi-layer, passive thermal insulator material the objective is to minimize potential conductive thermal paths, One method is to join the various layers together through use of conventional adhesives or thermal bonding techniques in either a continuous or discontinuous manner. Other techniques include binding the layers using cotton thread and buttons or just thread sewn in small points spaced far apart. Double layer seams can be used to join the sandwich sections to form a container.

Containers formed from the present product can have various shapes and sizes depending on the application. Cylindrical or box shapes are simplest and therefore lower costs. Preferably the cutting, layering and sewing to construct a container are fully automated although manual operations are possible.

The biodegradable multi-layer, passive thermal insulator material can be further combined with other active heating/cooling technology including but not limited to: thermoelectric heating/cooling using dissimilar metals (thermocouples), chemical phase changes substances, oxidative exothermic chemical reactions or other active sources such as resistive heating.

Phase change materials (“PCMs”) can also be used in the various layers of the biodegradable multi-layer, passive thermal insulator material to enhance its thermal resistivity. Encapsulated PCMs that comprise PCMs fully contained within spherical shells are preferred. The encapsulated PCMs come in various sizes, e.g., macro-encapsulated forms that are 3-4 mm and micro-encapsulated forms that can vary in size from 15-25 microns.

The thermal resistivity of the encapsulated PCMs can be set by selecting the melting point of the PCM. Typically, a low density wax or similar substance can be used in forming the PCMs that will melt in a wide range of temperatures, e.g., −30° C. to +40′ C. Micro-encapsulated PCMs are readily available, have a wide range of target temperatures and can be readily used to coat various materials. Microencapsulated PCMs can be used to coat the inner continuous layer(s), coat the inner discontinuous layer as well as forming the inner discontinuous layer. Micro-encapsulated PCMs provide for increased thermal resistance around a fixed target temperature.

While the thermal characteristics of the biodegradable multi-layer, passive thermal insulator material will vary depending on the materials used, they can be estimated for one embodiment as specified below. This theoretical estimate is based on the thermal resistivity of the components and the layer dimensions specified.

Table 1 provides the thermal resistivity of representative materials that may be used as the components that make up the present products. Where we could not find identical materials we have extrapolated from similar materials.

TABLE 1

| | Thermal | Thermal | |
|---|---|---|---|
| | Conductivity | Resistivity | |
| Material | W/(m · K) | m · K/W | Source |
| Air | 0.024* | 42* | Ref[1] |
| Beeswax | 0.25 | 4 | Ref[3] |
| Chitosan | 0.05-0.08 | 16 | Ref[4] |
| Cotton | 0.042-0.05 | 22 | Ref[5] |
| Paper | 0.05* | 20* | Ref[1] |

*These FIGURES at 25° C.

As the sources of the data vary, there is possibly significant variation in the conditions under which the measurements were taken. However they should be sufficiently accurate for an order of magnitude calculation of the thermal resistivity of the biodegradable multi-layer, passive thermal insulator material.

To calculate the thermal resistivity of the multiple layers of the biodegradable multi-layer, passive thermal insulator material, a weighted average of the thermal resistivity of each layer was used with the weighting factor being the thickness of the layer.

The following information was used in the calculations:

Inner layer
Continuous layer—Newsprint with a thickness of approximately 75 microns,
Discontinuous layer Cheesecloth (composition approximately cotton 20% and air 80%) and approximately 150 microns in thickness

Outer Layer
Inner Layer Chitosan, approximately 100 microns
Outer LayerBeeswax approximately 100 microns

The order of magnitude calculation of the thermal resistivity of various embodiments of the biodegradable multi-layer, passive thermal insulator material is summarized in Table 2.

TABLE 2

| | Outer layers | | | | Inner layers | | | | |
|---|---|---|---|---|---|---|---|---|---|
| | Beeswax | Chitosan | Paper | Total | Layers | Continuous | Discontinuous | Total | Aggregate |
| Example 1 | | | | | | | | | |
| One | | | | | | | | | |
| discontinuous | | | | | | | | | |
| layer | | | | | | | | | |
| Thickness | 200 | 200 | 75 | 475 | 1 | 75 | 150 | 225 | 700 |
| Thermal Resistivity | 4 | 16 | 20 | | | 20 | 36 | | |
| Product | 800 | 3200 | 1500 | 5500 | 1 | 1500 | 5400 | 6900 | 12400 |
| Av. Thermal Res. | 11.58 | | | | 30.67 | | | | 17.71 |
| Example 2 | | | | | | | | | |
| Five | | | | | | | | | |
| discontinuous | | | | | | | | | |
| layers | | | | | | | | | |
| Thickness | 200 | 200 | 75 | 475 | 5 | 75 | 150 | 1125 | 1600 |
| Thermal Resistivity | 4 | 16 | 20 | | | 20 | 36 | | |
| Product | 800 | 3200 | 1500 | 5500 | 5 | 1500 | 5400 | 34500 | 40000 |
| Av. Thermal Res. | 11.58 | | | | 30.67 | | | | 25 |
| Example 3 | | | | | | | | | |
| Ten | | | | | | | | | |
| discontinuous | | | | | | | | | |
| layers | | | | | | | | | |
| Thickness | 200 | 200 | 75 | 475 | 10 | 75 | 150 | 2250 | 2725 |
| Thermal Resistivity | 4 | 16 | 20 | | | 20 | 36 | | |
| Product | 800 | 3200 | 1500 | 5500 | 10 | 1500 | 5400 | 69000 | 74500 |
| Av. Thermal Res. | 11.58 | | | | 30.67 | | | | 27.34 |
| Example 4 | | | | | | | | | |
| Twenty | | | | | | | | | |
| discontinuous | | | | | | | | | |
| layers | | | | | | | | | |
| Thickness | 200 | 200 | 75 | 475 | 20 | 75 | 150 | 4500 | 4975 |
| Thermal Resistivity | 4 | 16 | 20 | | | 20 | 36 | | |
| Product | 800 | 3200 | 1500 | 5500 | 20 | 1500 | 5400 | 138000 | 143500 |

| | | | |
|---|---|---|---|
| Av. Thermal Res. | 11.58 | 30.67 | 28.84 |

* Thermal Resistivity in mK/W

The estimates indicate that, as the number of layers increases, the thermal resistivity of the biodegradable multi-layer, passive thermal insulator material can be increased towards a maximum which depends on the relative air content in the discontinuous layer. In the above examples, the calculated maximum thermal resistivity value is 31 mK/W while the product of Example 3 has a calculated value of 27.34 mK/W and the product of Example 4 has a calculated value of 28.84 mK/W.

As a comparison, Table 3 sets forth the thermal resistivity of common packaging materials.

TABLE 3

| | Thermal Resistivity | |
|---|---|---|
| Material | (mK/W) | Source |
| Insulation materials | From 6-29 | Ref[1] |
| Polystyrene | 33 | Ref[1] |
| Polyurethane Foam | 33 | Ref[1] |
| Cardboard | 20-25 | Ref[6] |
| Polyethylene Foam | 20 | Ref[6] |

While some of the synthetic insulating materials may provide a better thermal resistivity than the exemplified examples of the biodegradable multi-layer, passive thermal insulator material, they are of the same order of magnitude as the biodegradable multi-layer, passive thermal insulator material. However, the biodegradable multi-layer. passive thermal insulator material provides distinct advantages over these listed materials as follows:
thermal performance of the same order of magnitude as the best synthetic insulating materials
number of layers can be used to tailor the insulating properties to the needs of the materials to be packaged low cost to manufacture and to use
inert materials are used that will not contaminate food
can be fully biodegradable.

The biodegradable multi-layer, passive thermal insulator materials described herein are in no way limited to the described specific embodiments or the listing of specific components.

### REFERENCES

1. The Engineering Toolbox, http://www.engineeringtoolbox.com/thermal-conductivity-d_429.html
2. Singh S. P., et al., Packaging Technology and Science, Vol 21, 1. 1:25-35, January/February 2008, “Performance Comparison of Thermal Insulated Packaging Boxes, Bags and Refrigerants for Single-parcel Shipments”
3. DeracDelta.co.UK, Science and Engineering Encyclopedia, http://www.diracdelta.co.uk/science/source/t/h/thermal%20conduetion/source.html#. UbPRy9LF1Bk
4. Jean-Denis M, et al., Int J Mol Sci. 2011; 12(2): 1175-1186, “Development of a Chitosan-Based Biofoam: Application to the Processing of a Porous Ceramic Material” http://www.ncbi.nlm.nih.gov/pmc/artieles/PMC3083698/table/tl-ijms-12-01175/
5. Chidambararn Pr, et al., African Journal of Basic & Applied Sciences 4 (2):60-66, 2012, “Study of Therma Comfort Properties of Cotton/Regenerated Bamboo Knitted Fabrics” http://idosi.org/ajbas/ajbas4(2)12/6.pdf
6. Wikipedia R-Value(insulation), from table of per thickness R-values converted to common SI units, http://en.wikipedia.org/wiki/R-value_(insulation)
7. http://en.wikipedia.org/wiki/Phase-change_material
8. http://www.microteklabs.com/which-pcm-is-the-right-one-for-you.html)

What is claimed is:

1. A multi-layer, passive thermal insulator material comprising an inner layer positioned between two outer layers, wherein:
(i) the inner layer comprises multiple layers including at least one discontinuous layer containing pockets positioned between two continuous layers, said at least one discontinuous layer and two continuous layers being arranged so that the pockets of the discontinuous layer are sealed so as to trap a gas therein and;
(ii) the two outer layers each comprise at least two layers that provide structural strength and moisture protection to the inner layer.

2. A multi-layer, passive thermal insulator material according to claim 1 wherein the materials used for each layer are selected so that the material is biodegradable.

3. A multi-layer, passive thermal insulator material according to claim 1 wherein each of the two outer layers comprise a first layer providing structural strength positioned next to said inner layer and a second layer providing moisture resistance positioned on the side of the first layer opposite to the inner layer.

4. A multi-layer, passive thermal insulator material according to claim 3 wherein said first layer comprises chitosan.

5. A multi-layer, passive thermal insulator material according to claim 3 wherein said first layer comprises chitosan and said second layer comprises beeswax.

6. A multi-layer, passive thermal insulator material according to claim 4 wherein the discontinuous layer comprises woven or non-woven material.

7. A multi-layer, passive thermal insulator material according to claim 5 wherein the discontinuous layer comprises cheesecloth.

8. A multi-layer, passive thermal insulator material according to claim 1 further comprising a phase change material in at least one layer to enhance its thermal resistivity.

9. A multi-layer, passive thermal insulator material according to claim 7 wherein the phase change material is encapsulated.

10. A container comprising the multi-layer, passive thermal insulator material of claim 1.
